(19) United States
(12) Patent Application Publication
(10) Pub. No.: US 2025/0271809 A1
(43) Pub. Date: Aug. 28, 2025

(54) IMAGE FORMING APPARATUS WITH OVERWRITING OF DATA FROM PHOTOSENSITIVE DRUM

(71) Applicant: Hewlett-Packard Development Company, L.P., Spring, TX (US)

(72) Inventor: Pablo Alberto LOMELI, Boise, ID (US)

(21) Appl. No.: 18/857,546

(22) PCT Filed: Apr. 20, 2022
(86) PCT No.: PCT/US2022/025605

§ 371 Date: Oct. 17, 2024

(51) Int. Cl. G03G 21/04; G03G 15/00; G03G 15/22; G06K 15/00; G06K 15/02

(52) U.S. Cl. CPC G03G 21/04; G03G 15/22; G03G 15/5016; G06K 15/005; G06K 15/1803; G06K 15/4095

(57) ABSTRACT

In some examples, a printing device includes drum components, colorant components, and a controller coupled to the drum components and the colorant components. The controller determines a drum data erase is to be performed, generates erasure data in response to the determination, and performs the drum data erase using the erasure data. The drum data erase includes causing the colorant components to transfer a colorant to a drum surface of a drum of the drum components according to a pattern of the erasure data.

BACKGROUND

Printing devices such as laser printers or solid ink printers include a drum. A printing device deposits a colorant onto a surface of the drum to form an image for printing. The printing device transfers the image from the drum surface to a receiving medium, such as paper.

### BRIEF DESCRIPTION OF THE DRAWINGS

Various examples are described below referring to the following figures.

FIG. 1 is a block diagram of a printing device for performing drum data erasures, in accordance with various examples.

FIG. 2 is a block diagram of a graphical user interface (GUI) for an application for performing drum data erasures, in accordance with various examples.

FIG. 3 is a block diagram of a GUI for an application for performing drum data erasures, in accordance with various examples.

FIG. 4 is a block diagram of a GUI for an application for performing drum data erasures, in accordance with various examples.

FIG. 5 is a block diagram of a printing device for performing drum data erasures, in accordance with various examples.

FIG. 6 is a flow diagram of a method for a printing device for performing drum data erasures, in accordance with various examples.

FIG. 7 is a flow diagram of a method for a printing device for performing drum data erasures, in accordance with various examples.

### DETAILED DESCRIPTION

As described above, printing devices, such as laser printers or solid ink printers, generate an image by depositing a colorant onto a drum surface to form the image and then transferring the image from the drum surface to a receiving medium. A colorant, as used herein, refers to toner, solid ink, liquid ink, or other suitable material for forming the image onto the drum surface. For laser printers, a laser etches an electrically charged image onto a drum surface. Colorant components transfer toner from a reservoir onto the drum surface. The toner is attracted to charged areas that form the image on the drum surface. For solid ink printers, colorant components heat a solid wax ink. To form the image, the colorant components deposit a resulting liquid ink onto the drum surface, which is heated to maintain the liquid state of the ink. Rotations of drum components, which include the drum, and feed components result in the transfer of the image from the drum surface to the receiving medium, such as paper. After transfer to the receiving medium, residual colorant may remain deposited on the drum surface. While some printing devices erase the drum surface prior to a subsequent print job, in an attempt to access secured information that was printed during a print job, malicious third-parties may access the drum surface having the residual colorant between the print jobs.

This description describes a printing device that enhances a security of data transferred to a drum surface of a drum of a printing device by transferring erasure data to the drum surface. A controller of the printing device determines that a drum data erase is to be performed. In some examples, the controller determines that the drum data erase is to be performed in response to completion of a print job. In other examples, the controller determines that the drum data erase is to be performed in response to receiving a command to perform the drum data erase. The command is received via a graphical user interface (GUI) of the printing device, for example. In another example, the command is received via a wireless interface that couples the printing device to an electronic device. In response to the determination that the drum data erase is to be performed, the controller generates erasure data. In some examples, the controller retrieves the erasure data from a storage device to generate the erasure data. In various examples, the controller determines a security level of data of a print job and retrieves an erasure data associated with the security level. The controller performs the drum data erase using the erasure data. Performing the drum data erase includes causing colorant components of the printing device to transfer a colorant to the drum surface of the drum of the drum components. In some examples, performing the drum data erase includes printing the erasure data onto a receiving medium, such as paper.

By transferring the erasure data to the drum surface, the printing device obscures or erases residual data of a print job remaining on the drum surface. Obscuring or erasing the residual data of the print job enhances a security of the printing device by blocking third parties from accessing the data of the print job via the drum surface.

In some examples in accordance with the present description, a printing device is provided. The printing device includes drum components, colorant components, and a controller. The controller is coupled to the drum components and the colorant components. The controller determines a drum data erase is to be performed, generates erasure data in response to the determination, and performs the drum data erase using the erasure data. The drum data erase includes causing the colorant components to transfer a colorant to a drum surface of a drum of the drum components according to a pattern of the erasure data.

In some examples in accordance with the present description, a non-transitory machine-readable medium storing machine-readable instructions is provided. The term “non-transitory,” as used herein, does not encompass transitory propagating signals. The machine-readable instructions, when executed by a controller, cause the controller to receive a command to perform a drum data erase, generate erasure data in response to the command, and perform the drum data erase using the erasure data.

In some examples in accordance with the present description, a method is provided. The method includes receiving, by a controller of a printing device, a request to print a print job, printing, by the printing device, the print job, transferring, by the controller, a first pattern of erasure data to a drum surface of a drum of the printing device, and transferring, by the controller, a second pattern of the erasure data to the drum surface.

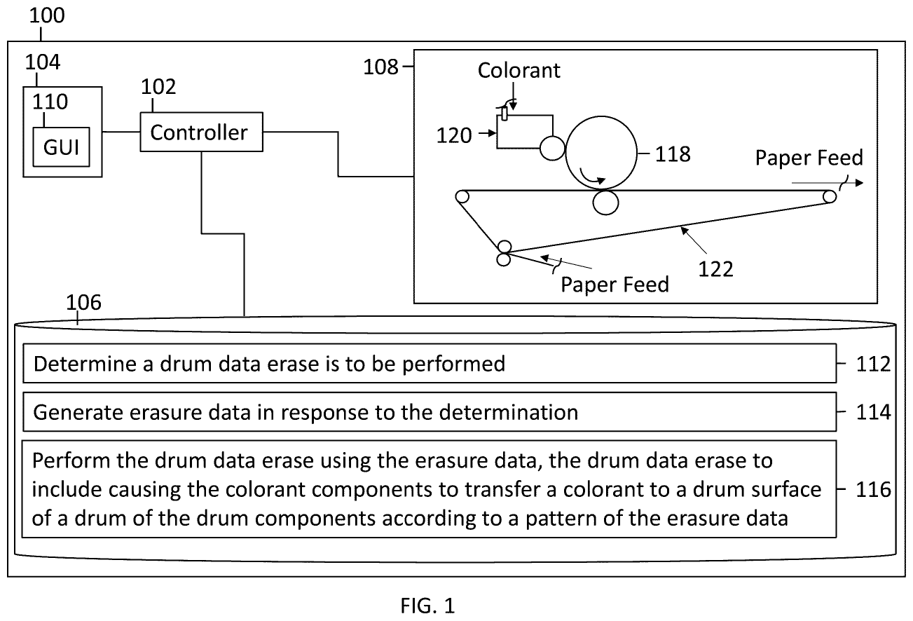

Referring now to FIG. 1, a block diagram of a printing device 100 for performing drum data erasures is shown, in accordance with various examples. The printing device 100 is a laser printer, a solid ink printer, or other suitable image forming apparatus that includes a drum component 118, for example. The printing device 100 includes a controller 102, a touchscreen device 104, a storage device 106, and image transfer components 108. The controller 102 is a microcontroller, a microcomputer, a programmable integrated circuit, a programmable gate array, or other suitable device for managing operations of the printing device 100 or operations of a component or multiple components of the printing device 100. The touchscreen device 104 is an input/output device that enables a user to interact with applications of the printing device 100. Although not shown, in various examples the touchscreen device 104 is augmented, or replaced by, tactile buttons or other input/output controls. An application, as used herein, is executable code implemented using machine-readable instructions, which, when executed by the controller 102, cause the controller 102 to perform tasks indicated by the executable code. The touchscreen device 104 includes a graphical user interface 110 (GUI 110) that enables the user to interact with an application, for example. The storage device 106 is a hard drive, a solid-state drive (SSD), flash memory, random access memory (RAM), or other suitable memory for storing data or machine-readable instructions of the printing device 100.

The image transfer components 108 include a drum component 118, colorant components 120, paper feed components 122, and other suitable components for transferring an image from a drum surface of the drum component 118 to paper. The drum component 118 is a drum of the printing device 100, for example. The colorant components 120 include components for transferring a colorant from a reservoir to the drum surface. The paper feed components 122 move paper, or other receiving medium, from a paper tray (not explicitly shown) to receive the image from the drum surface and to an output bin or tray (not explicitly shown). While not explicitly shown, in some examples, the printing device 100 includes wired connectors (e.g., Ethernet, universal serial bus (USB)), wireless connectors (e.g., BLUETOOTH, WI-FI), or other suitable interfaces for communicating with electronic devices such as desktops, laptops, smartphones, tablets, or notebooks.

In various examples, the controller 102 is coupled to the touchscreen device 104, the storage device 106, and the image transfer components 108. In some examples, the controller 102 is coupled to the drum component 118, the colorant components 120, and the paper feed components 122.

In some examples, the storage device 106 stores machine-readable instructions 112, 114, 116, which, when executed by the controller 102, cause the controller 102 to perform some or all of the actions attributed herein to the controller 102. The machine-readable instructions 112, 114, 116, when executed by the controller 102, cause the controller 102 to perform drum data erasures, for example. The machine-readable instruction 112, when executed by the controller 102, causes the controller 102 to determine a drum data erase is to be performed. The machine-readable instruction 114, when executed by the controller 102, causes the controller 102 to generate erasure data in response to the determination. The machine-readable instruction 116, when executed by the controller 102, causes the controller 102 to perform the drum data erase using the erasure data. The drum data erase includes causing the colorant components 120 to transfer a colorant to a drum surface of the drum component 118 according to a pattern of the erasure data.

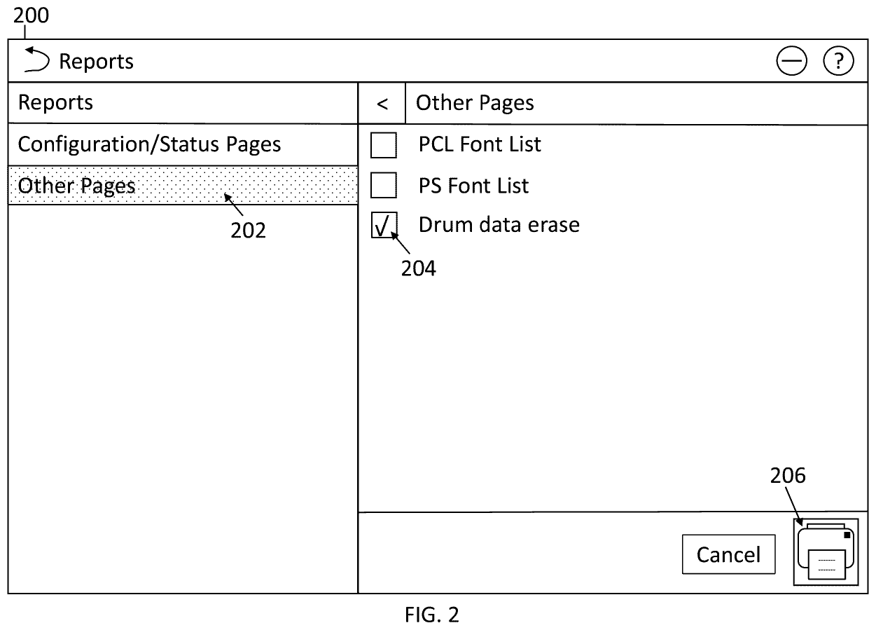

As described above, in some examples, the controller 102 determines that the drum data erase is to be performed in response to completion of a print job. For example, upon completion of the print job, the controller 102 generates the erasure data and performs the drum erase. In other examples, the controller 102 determines that the drum data erase is to be performed in response to receiving a command to perform the drum data erase. The command is received via the GUI 110, for example, as described below with respect to FIG. 2, 3, or 4. In another example, the command is received from an electronic device (not explicitly shown). For example, a user selects an option to perform the drum erase from a GUI of the electronic device. The GUI of the electronic device is a GUI of an application that interfaces with the printing device 100. The electronic device transmits the command to the printing device 100. In some examples, the electronic device transmits the command to the printing device 100 via a wired connection (not explicitly shown). In other examples, the electronic device transmits the command to the printing device 100 via a wireless connection (not explicitly shown).

In response to the determination that the drum data erase is to be performed, the controller 102 generates erasure data. For example, the controller 102 determines a pattern that obscures or erases a specified area of the drum surface. The specified area of the drum surface is a multiplier of a total area of the drum surface. For example, the controller 102 determines that the pattern is to obscure or erase 90% of the total drum surface by retrieving the multiplier from the storage device 106. In another example, the controller 102 determines the multiplier based on a level of colorant. In response to the level of the colorant being greater than a first threshold, the controller 102 selects erasure data that includes multiple patterns. In response to the level of the colorant being equivalent to or less than a second threshold, the controller 102 selects erasure data that includes a single pattern. In response to the level of the colorant being greater than the second threshold and equivalent to or less than the first threshold, the controller 102 selects erasure data that includes a number of patterns that is less than the multiple patterns used in response to the level of the colorant being greater than the first threshold and greater than the single pattern.

In various examples, the controller 102 generates the erasure data using alphanumeric characters, symbols, or a combination thereof. In some examples, the controller 102 determines that the erasure data includes multiple alphanumeric characters, symbols, or the combination thereof. The multiple characters include, [symbol] ” “O,” “#”, “X,” “@,” “+,” “Q,” “W,” “M,” “D,” “G,” “8,” “B,” “%,” “a,” “e,” “S,” “s,” “z,” “Z,” “&,” “$,” or other suitable alphanumeric characters or symbols that obscure or erase the specified area of the drum surface. For example, the controller 102 determines that erasure data including a pattern of “O”s, “#”s, “X”s, or a combination thereof, obscures or erases the specified area of the drum surface. In another example, the controller 102 determines that erasure data including a first pattern that includes “@”s, a second pattern that includes “X”s, and a third pattern that includes “+”s obscures or erases the specified area of the drum surface. In other examples, the controller 102 determines that erasure data includes a single character. The single character is [symbol] or other suitable alphanumeric character or symbol that obscures or erases the specified area of the drum surface, for example.

In some examples, the controller 102 retrieves the erasure data from the storage device 106 to generate the erasure data. For example, the erasure data that includes the patterns that include “O”s, “#”s, “X”s, or a combination thereof, is stored to the storage device 106. In various examples, the controller 102 determines the security level of data of the print job and retrieves from the storage device 106 an erasure data associated with the security level. A security level, as used herein, indicates a confidentiality or sensitivity level of the data. The controller 102 determines the security level of the data of the print job using a data file that includes the security level of the print job, for example. In another example, a user specifies the security level utilizing the GUI 110. In response to the security level, the controller 102 retrieves the erasure data from the storage device 106.

For example, a first erasure data stored to the storage device 106 includes the patterns that include “@”s, “X”s, “+”s, or a combination thereof, a second erasure data stored to the storage device 106 includes patterns that include “Q”s, “W”s, “M”s, “a”s, or a combination thereof, a third erasure data stored to the storage device 106 includes the pattern that includes [symbol] and a fourth erasure data stored to the storage device 106 includes a pattern that includes “@”s, “%”s, or a combination thereof. In response to the controller 102 determining that the security level of the data of the print job indicates a first specified area of the drum surface is to be obscured or erased, the controller 102 retrieves the third erasure data. In response to the controller 102 determining that the security level of the data of the print job indicates a second specified area of the drum surface is to be obscured or erased, the controller 102 retrieves the first erasure data. In response to the controller 102 determining that the security level of the data of the print job indicates a third specified area of the drum surface is to be obscured or erased, the controller 102 retrieves the second erasure data. In some examples, the controller 102 determines which erasure data of the multiple erasure data stored to the storage device 106 based on the level of colorant and the security level. Level of colorant, as used herein, indicates an amount of colorant remaining in a reservoir or other suitable container for the colorant. For example, in response to the controller 102 determining that the security level of the data of the print job indicates the third specified area of the drum surface is to be obscured or erased and that the level of colorant is greater than the second threshold and equivalent to or less than the first threshold, the controller 102 retrieves the fourth erasure data.

The controller 102 performs the drum data erase using the erasure data. Performing the drum data erase includes causing the colorant components 120 of the printing device 100 to transfer a colorant to the drum surface of the drum component 118. In some examples, the controller 102 causes a pattern of the erasure data to be transferred to the drum surface. The controller 102 repeats the pattern on the drum surface for a full rotation (e.g., 360 degree rotation) of the drum component 118, for example. In another example, the controller 102 repeats the pattern on the drum surface for multiple rotations of the drum component 118, such as according to the level of colorant, the security level, or a combination thereof. The controller 102 repeats the transfer for each pattern of the erasure data. In other examples, the controller 102 alternates the multiple characters of the pattern on the drum surface for a full rotation. The controller 102 shifts the multiple characters of the pattern to have a different order on the drum surface for a number of rotations that is equivalent to or greater than a number of characters of the pattern. For example, the controller 102 transfers the characters “O,” “#,” “X” in a repeated manner onto the drum surface for a first full rotation, transfers the characters “#,” “X,” “O” in a repeated manner onto the drum surface for a second full rotation, and transfers the characters “X”, “O,” “#” in a repeated manner onto the drum surface for a third full rotation. In this manner, an area of the drum surface receives each character of the pattern in a sequential manner.

In other examples, performing the drum data erase includes printing the erasure data onto a receiving medium. For example, the controller 102 cause a page of “O”s to be printed, a page of “#”s to be printed, and a page of “X”s to be printed. In another example, the controller 102 causes multiple pages of each character to be printed. In another example, the controller 102 causes a first rotation of the drum component 118 to print “@”s, a second rotation of the drum component 118 to print “X”s, and a third rotation of the drum component 118 to print “+”s.

In various examples, the specified area of the drum surface, the multiplier, the specified area of the drum surface relative to a security level, thresholds, or a combination thereof, are determined at a time of manufacture. In other examples, the specified area of the drum surface, the multiplier, the specified area of the drum surface relative to a security level, thresholds, or the combination thereof, are determined by a user having a specified level of security access to the printing device 100. In some examples, a user who generated the print job determines the specified area, the multiplier, the specified area of the drum surface relative to a security level, thresholds, or the combination thereof, using the GUI 110 or the GUI of the electronic device coupled to the printing device 100. In some examples, the specified area of the drum surface, the multiplier, the specified area of the drum surface relative to a security level, thresholds, or the combination thereof, are set at the time of manufacture and modifiable by a user as described above.

By transferring the erasure data to the drum surface, the printing device 100 obscures or erases residual data of a print job remaining on the drum surface. Obscuring or erasing the residual data of the print job enhances a security of the printing device 100 by blocking third parties from accessing the data of the print job via the drum surface.

Referring now to FIG. 2, a block diagram of a GUI 200 for an application for performing drum data erasures is shown, in accordance with various examples. The GUI 200 is the GUI 110, for example. In another example, the GUI 200 is a GUI of an electronic device coupled to a printing device (e.g., the printing device 100). The GUI 200 includes menu options 202, 204, 206. A menu option 202 is a command for a controller (e.g., the controller 102) of the printing device to cause a display of an “Other Pages” menu. A menu option 204 is a menu option of the “Other Pages” menu. The menu option 204 indicates the controller is to perform a drum data erasure, for example. A menu option 206 is a command for the controller to perform a selected option from the “Other Pages” menu.

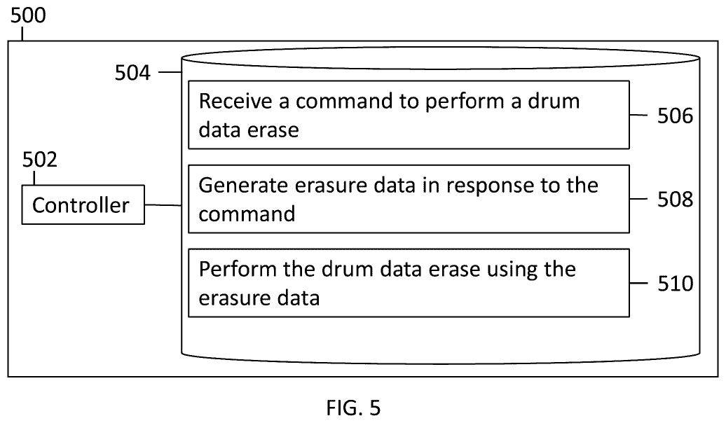

In some examples, a user selects the menu option 202 to display the “Other Pages” menu. The menu option 202 is highlighted, as shown by the black-dotted white background, to indicate the user has selected the menu option 202. The user selects the menu option 204 to indicate to perform the drum data erasure. The menu option 204 is selected, as shown by the check mark in the box associated with the menu option 204. In response to the user selecting the menu option 206, the printing device performs the drum data erasure, as described above with respect to FIG. 1 or below with respect to FIG. 5, 6, or 7.

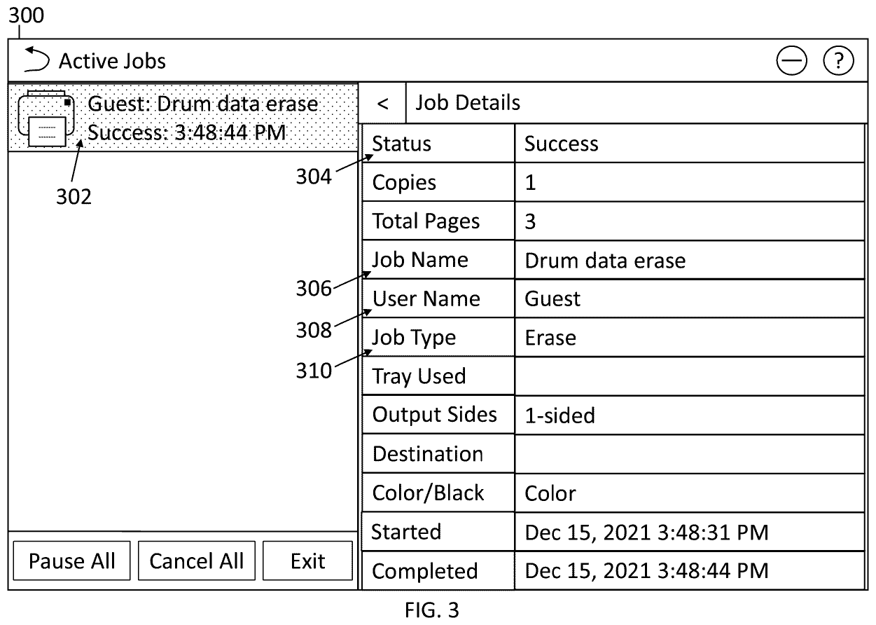

Referring now to FIG. 3, a block diagram of a GUI 300 for an application for performing drum data erasures is shown, in accordance with various examples. The GUI 300 is the GUI 110, for example. In another example, the GUI 300 is a GUI of an electronic device coupled to a printing device (e.g., the printing device 100). In some examples, the GUI 300 is a second window of the GUI 200. The GUI 300 includes a menu option 302 and status information 304, 306, 308, 310. A menu option 302 is a command for a controller (e.g., the controller 102) of the printing device to cause a display of a “Job Details” status window. The menu option 302 is a menu option of the “Active Jobs” menu, for example. Data of the menu option 302 includes information of the “Job Details” status window, for example. A status information 304 indicates whether a print job is successful or unsuccessful, for example. A status information 306 indicates a name of the print job, for example. A status information 308 indicates a user name, for example. A status information 310 indicates a type of the print job, for example.

A type of the print job, as used herein, indicates a technique to perform using the data of the print job. For example, a print type of print job indicates the data is transferred to the receiving medium, a digital type of print job indicates the data is transferred to a digital format, such as a .pdf, .gif, .img, or other suitable format, and an erase type of print job indicates the data is transferred to the drum surface and then removed without printing or digitization. In other examples, the types of print jobs include different techniques to perform using the data of the print job.

In some examples, a user selects the menu option 302 to display the “Job Details” menu. Data of the menu option 302 is highlighted, as shown by the black-dotted white background, to indicate the user has selected the menu option 302. Data of the menu option 302 includes the user name, the name of the print job, whether the print job was successful or not, the type of the print job, or a combination thereof. In response to the selection of the menu option 302, the controller causes the display of the status information associated with the menu option 302. For example, the status information shows that the drum data erase is successful. In some examples, a “Copies” status information shows how many times the drum data erase is performed. In other examples, a “Total Pages” status information shows how many pages were printed. In various examples, a “Job Type” status information shows whether the erasure data is transferred to a drum (e.g., the drum component 118) and printed the image or whether the erasure data is transferred to the drum without printing the image. In various examples, in response to the type of the print job indicating that the erasure data is transferred to the drum surface without printing the erasure data to the receiving medium, the number of pages printed indicates a number of full rotations the drum has turned, a number of pages that would have been printed, or a combination thereof.

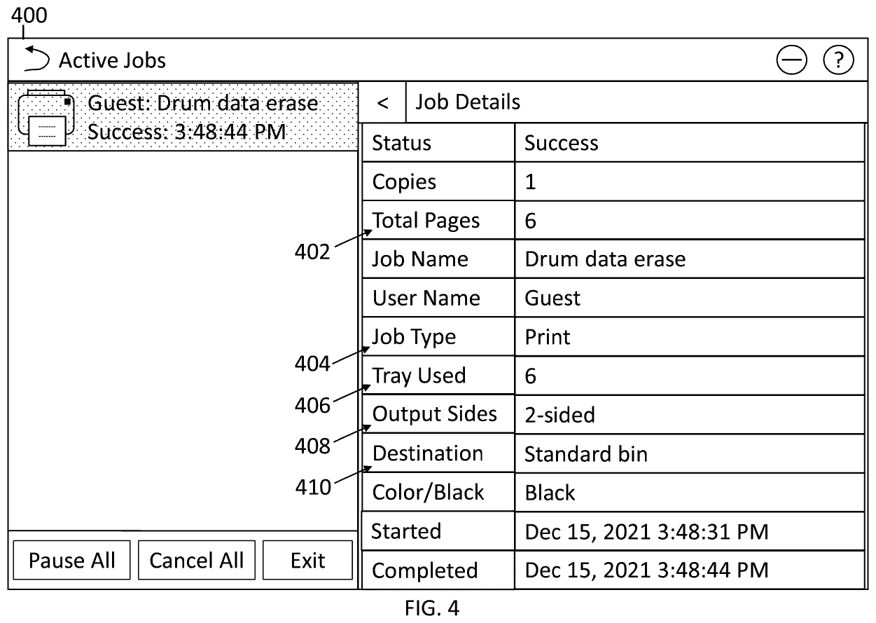

Referring now to FIG. 4, a block diagram of a GUI 400 for an application for performing drum data erasures is shown, in accordance with various examples. The GUI 400 is the GUI 110, for example. In another example, the GUI 400 is a GUI of an electronic device coupled to a printing device (e.g., the printing device 100). In some examples, the GUI 400 is a second window of the GUI 200. The GUI 400 includes status information 402, 404, 406, 408, 410. A status information 402 indicates a number of pages of the print job, for example. A status information 404 indicates a type of the print job, for example. A status information 406 indicates a tray from which a receiving medium is fed to a drum (e.g., the drum component 118), for example. A status information 408 indicates whether to print on a single side or both sides of the receiving medium, for example. A status information 410 indicates a destination to which the receiving medium is deposited, for example.

In some examples, a user selects the menu option highlighted by the black-dotted white background. In response to the selection of the menu option, the controller causes the display of the status information associated with the menu option, as described above with respect to FIG. 3, for example. The status information shows that the drum data erase is successful. In various examples, FIG. 4 shows a difference between a print type of drum data erase and an erase type of drum data erase, as shown in FIG. 3. For example, the status information 404 shows that the type of drum data erase includes printing the erasure data. The status information 402 shows that 6 pages are printed. The status information 406 shows that Tray 6 provided the receiving medium to which the erasure data is printed. The status information 408 shows that the erasure data is printed to both sides of the receiving medium. The status information 410 shows that the receiving medium is deposited in a “Standard bin” after the erasure data is transferred to the receiving medium.

By using the “erase” type of drum data erase, the printing device conserves receiving medium by not printing the erasure data to the receiving medium. Using the “print” type of drum data erase provides tangible proof that the drum data erase was performed. The drum data erase enables erasing of the drum surface in printing devices without eraser components.

Referring now to FIG. 5, a block diagram of a printing device 500 for performing drum data erasures is shown, in accordance with various examples. The printing device 500 is the printing device 100, for example. The printing device 500 includes a controller 502 and a non-transitory machine-readable medium 504. The controller 502 is the controller 102, for example.

In various examples, the controller 502 is coupled to the non-transitory machine-readable medium 504. In some examples, the non-transitory machine-readable medium 504 stores machine-readable instructions 506, 508, 510, which, when executed by the controller 502, cause the controller 502 to perform some or all of the actions attributed herein to the controller 502. The machine-readable instructions 506, 508, 510, when executed by the controller 502, cause the controller 502 to perform drum data erasures, for example. The machine-readable instruction 506, when executed by the controller 502, causes the controller 502 to receive a command to perform a drum data erase. The machine-readable instruction 508, when executed by the controller 502, causes the controller 502 to generate erasure data in response to the command. The machine-readable instruction 510, when executed by the controller 502, causes the controller 502 to perform the drum data erase using the erasure data.

In various examples, the controller 502 receives the command to perform the drum data erase from a GUI (e.g., the GUI 110, 200). In response to receiving the command, the controller 502 generates the erasure data using the techniques described above with respect to FIG. 1, for example. The controller 502 performs the drum data erase using the techniques described above with respect to FIG. 1, for example.

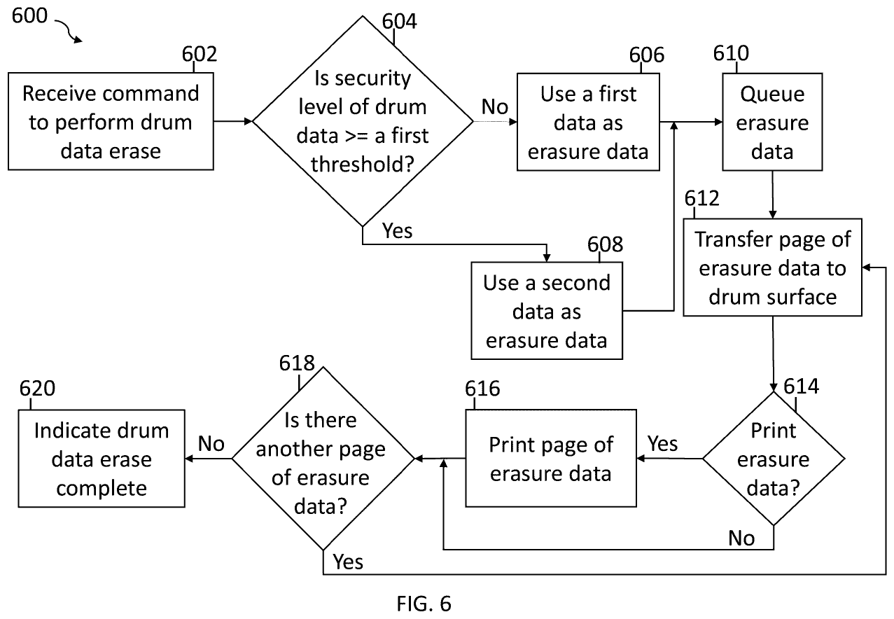

Referring now to FIG. 6, a flow diagram of a method 600 for a printing device (e.g., the printing device 100, 500) for performing drum data erasures is shown, in accordance with various examples. The method 600 includes receiving a command to perform a drum data erase (602). The method 600 also includes determining whether a security level of drum data is equivalent to or greater than a threshold (604). Additionally, the method 600 includes using a first data as erasure data (606) in response to a determination that the security level of the drum data is less than the threshold. In response to a determination that the security level of the drum data is equivalent to or greater than the threshold, the method 600 includes using a second data as erasure data (608).

The method 600 includes queueing the erasure data (610). The method 600 also includes transferring a page of erasure data to a drum surface (612). Additionally, the method 600 includes determining whether to print the erasure data (614). In response to a determination that the erasure data is to be printed, the method 600 also includes printing the page of the erasure data (616). The method 600 includes determining whether the erasure data includes another page of erasure data (618) in response to a determination that the erasure data is not to be printed or in response to completing printing the page of the erasure data. In response to a determination that the erasure data includes another page of erasure data, the method 600 includes returning to transferring a page of erasure data to a drum surface (612). In response to a determination that the erasure data does not include another page of erasure data, the method 600 also includes indicating that the drum data erase is complete (620).

In various examples, the method 600 includes receiving the command to perform the drum data erase using the techniques described above with respect to FIG. 1, 2, or 5. The method 600 also includes determining whether the security level of drum data is equivalent to or greater than the threshold using the techniques described above with respect to FIG. 1, for example.

In some examples, the method 600 includes determining the security level of the drum data using the techniques described above with respect to FIG. 1. In various examples, the method 600 includes determining which erasure data of erasure data stored to a storage device (e.g., the storage device 106, the non-transitory machine-readable medium 504) to use in response to the security level using the techniques described above with respect to FIG. 1. In other examples, the method 600 includes generating the erasure using the techniques described above with respect to FIG. 1 in response to the security level.

In various examples, the method 600 includes queueing the erasure data. Queueing the erasure data stores pages of the erasure data in an order for transferring to a drum surface (e.g., the drum component 118). In an “erase” type of drum data erase, the pages indicate the number of full rotations the drum has turned, a number of pages that would have been printed, or a combination thereof, as described above with respect to FIG. 1 or 4, for example. The method 600 also includes transferring a page of the erasure data to the drum surface as described above with respect to FIG. 1, for example.

In some examples, the method 600 includes determining whether to print the erasure data by receiving a command via a GUI. In various examples, the method 600 includes determining whether the erasure data includes another page of erasure data (618) by determining whether additional pages are queued. The method 600 includes indicating that the drum data erase is complete by causing the GUI to show the drum data erase is completed, as shown in FIG. 3 or 4, for example.

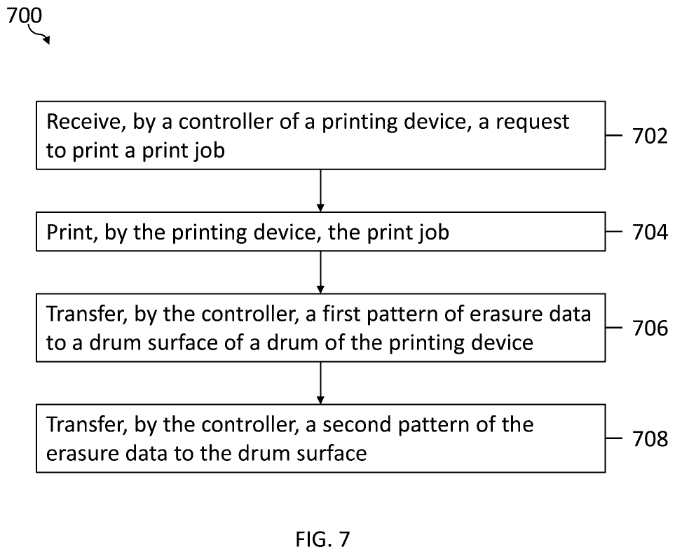

FIG. 7 is a flow diagram of a method 700 for a printing device (e.g., the printing device 100, 500) for performing drum data erasures, in accordance with various examples. The method 700 includes receiving, by a controller (e.g., the controller 102, 502) of the printing device, a request to print a print job (702). The method 700 also includes printing, by the printing device, the print job (704). Additionally, the method 700 includes transferring, by the controller, a first pattern of erasure data to a drum surface of a drum of the printing device (706). The method 700 also includes transferring, by the controller, a second pattern of erasure data to the drum surface (708).

In various examples, the method 700 includes receiving the request to print a print job from an electronic device coupled to the printing device. In response to completion of the print job, the method 700 also includes performing a drum data erasure by transferring the patterns of the erasure data using the techniques described above with respect to FIG. 1, 4, 5, or 6, for example.

Unless infeasible, some or all of the method 600, 700, may be performed by a controller (e.g., the controller 102, 502) concurrently or in different sequences and by circuity of a printing device (e.g., the printing device 100, 500), execution of machine-readable instructions of the printing device (e.g., the machine-readable instructions 112, 114, 116, the machine-readable instructions 506, 508, 510), or a combination thereof. For example, the method 600, 700 is implemented by machine-readable instructions stored to a storage device (e.g., the storage device 106, the non-transitory machine-readable medium 504, or another storage device not explicitly shown of the printing device), components (some of which are not explicitly shown) of the printing device, or a combination thereof. The controller executes the machine-readable instructions to perform some or all of the method 600, 700, for example.

While some components are shown as separate components of the printing device 100, 500, in other examples, the separate components are integrated in a single package. For example, the storage device 106 is integrated with the controller 102. The single package may herein be referred to as an integrated circuit (IC) or an integrated chip (IC).

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

In the above description and in the claims, the term “comprising” is used in an open-ended fashion, and thus should be interpreted to mean “including, but not limited to . . . ” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. A printing device, comprising:
drum components;
colorant components; and
a controller coupled to the drum components and the colorant components,
the controller to:
determine a drum data erase is to be performed;
generate erasure data in response to the determination; and
perform the drum data erase using the erasure data, the drum data erase to include causing the colorant components to transfer a colorant to a drum surface of a drum of the drum components according to a pattern of the erasure data.

2. The printing device of claim 1, wherein the printing device is a laser printer or a solid ink printer.

3. The printing device of claim 1, wherein the printing device comprises a touchscreen, and wherein the controller is to cause the touchscreen to display a type of the drum data erase.

4. The printing device of claim 3, wherein the type of the drum data erase indicates that the erasure data is transferred to the drum surface without printing the erasure data to a receiving medium.

5. The printing device of claim 1, wherein the pattern obscures or erases a specified area of the drum surface.

6. A non-transitory machine-readable medium storing machine-readable instructions, which, when executed by a controller, cause the controller to:
receive a command to perform a drum data erase;
generate erasure data in response to the command; and
perform the drum data erase using the erasure data.

7. The non-transitory machine-readable medium of claim 6, wherein the controller is to receive the command via a graphical user interface.

8. The non-transitory machine-readable medium of claim 6, wherein the controller is to generate the erasure data using multiple alphanumeric characters, symbols, or a combination thereof.

9. The non-transitory machine-readable medium of claim 8, wherein the controller is to cause the erasure data to be printed to a receiving medium.

10. The non-transitory machine-readable medium of claim 6, wherein the erasure data includes multiple patterns.

11. The non-transitory machine-readable medium of claim 10, wherein the erasure data includes [symbol] “O,” “#”, “X,” “@,” “+,” “Q,” “W,” “M,” “D,” “G,” “8,” “B,” “%,” “a,” “e,” “S,” “s,” “z,” “Z,” “&,” “$,” or a combination thereof.

12. A method, comprising:
receiving, by a controller of a printing device, a request to print a print job;
printing, by the printing device, the print job;
transferring, by the controller, a first pattern of erasure data to a drum surface of a drum of the printing device; and
transferring, by the controller, a second pattern of the erasure data to the drum surface.

13. The method of claim 12, wherein the first pattern includes multiple characters.

14. The method of claim 13, wherein the second pattern includes the multiple characters of the first pattern having a different order.

15. The method of claim 12, comprising:
generating, by the controller, the first pattern; and
generating, by the controller, the second pattern.
